(19) United States
(12) Patent Application Publication
(10) Pub. No.: US 2017/0252262 A1
(43) Pub. Date: Sep. 7, 2017

(54) ASSEMBLING TYPE SPORTS INSTRUMENT

(71) Applicant: Li Ting Feng Co., Ltd., Tainan (TW)

(72) Inventor: WEN-SUNG CHANG, Tainan (TW)

(21) Appl. No.: 15/061,581

(22) Filed: Mar. 4, 2016

(51) Int. Cl. A61H 15/00

(52) U.S. Cl. CPC A61H 15/00; A61H 2201/1664; A61H 2201/1671

(57) ABSTRACT

An assembling type sports instrument comprises a hollow column and a plurality of assembly parts. The hollow column includes an outer surface on the outer circumference thereof, an inner surface on the inner circumference thereof, and a plurality of column through-holes each penetrating the outer surface and the inner surface. Each assembly part includes a massage member and a connection member connected with the massage member. Each massage member comprises a construction at one end, which is far away from the connection member. Each connection member can be detachably connected with one of the column through-holes. While one assembly part is connected with the column through-hole, the construction thereof protrudes from the outer surface.

### FIELD OF THE INVENTION

The present invention relates to an assembling type sports instrument, particularly to an assembling type sports instrument whose massage block combinations can be changed to achieve different massage effects.

### BACKGROUND OF THE INVENTION

With change of labor market, most of labor population have flowed from traditional agriculture and animal husbandry to industry and commerce. The life style of most people is also transformed from intense labor into office and business work needing sitting all day long. Therefore, many office workers often go to gymnasiums or the like spots, which have many sports instruments, for maintaining heath and enhancing physical strength in spare time. Although having better sports effect, those sports instruments occupy much space. Further, the charge for using the sports instruments is pretty high. Besides, the sports instruments in gymnasiums usually have higher sports intensity and are not necessarily suitable for some people.

Refer to FIG. 1A. Thus, there is a massage roller available in the market, which has a hollow column and massage blocks protruding from the surface of the hollow column. The user places the massage roller on his waist or feet and rolls the massage roller to generate different massage effects on the muscle. However, the massage blocks are bound to the hollow column fixedly in the current massage rollers. The user is unlikely change the shapes or sizes of the massage blocks freely. If the user intends to enjoy different massage effects, he has to buy various types of massage devices, which are uneconomical and inconvenient to collect. Therefore, the conventional technology still has room to improve.

### SUMMARY OF THE INVENTION

One objective of the present invention is to solve the problem that the conventional massage instrument only has a single shape and the massage effect thereof is unlikely to change.

To achieve the abovementioned objective, the present invention provides an assembling type sports instrument, which comprises a hollow column and a plurality of assembly parts. The hollow column includes an outer surface on the outer circumference thereof, an inner surface on the inner circumference thereof, and a plurality of column through-holes each penetrating the outer surface and the inner surface. Each assembly part includes a massage member and a connection member connected with the massage member. Each massage member comprises a construction at the end far away from the connection member. Each connection member can be detachably connected with one column through-hole. While one assembly part is connected with the column through-hole, the construction thereof protrudes from the outer surface.

In one embodiment, each massage member comprises a press-fit socket at one end thereof, which is far away from the construction, and wherein each connection member comprises a connection rod, which is to be inserted into the column through-hole; and a first press-fit plate, which is to be detachably connected with the press-fit socket.

In one embodiment, the connection rod and the column through-hole respectively have tapered shapes corresponding to each other.

In one embodiment, the hollow column comprises two open ends respectively at two sides in the axial direction, and the assembling type sports instrument further comprises two cap members, which can be detachably connected with the open ends.

In one embodiment, the cap member includes a cap body disposed opposite the open end, a cap wall extended from the cap body and detachably connected with the open end, and a plurality of wall through-holes formed corresponding to the column through-holes.

In one embodiment, each connection member comprises a flexible second press-fit plate disposed at one end thereof, which is far away from the massage member; the second press-fit plate has a diameter greater than that the column through-hole; while the connection member is connected with the column through-hole, the second press-fit plate presses against the inner surface.

In one embodiment, the assembling type sports instrument further comprises a joint assembly part; the joint assembly part includes a joint assembly layer corresponding to the outer surface and a plurality of assembly layer through-holes formed on the joint assembly layer and respectively corresponding to the column through-holes.

In one embodiment, the construction is in form of a pyramid, a trapezoid, a sphere, a hemisphere, or a tooth.

In one embodiment, the hollow column is made of a material selected from a group including acrylonitrile-butadiene-styrene (ABS) copolymer, polycarbonate (PC), polyethylene (PE), polyvinyl chloride (PVC), and a thermoplastic elastomer (TPE).

In one embodiment, the assembly parts 20a is made of a material selected from a group including polycarbonate (PC), polyethylene (PE), ethylene-vinyl acetate (EVA) copolymer, natural rubber, artificial rubber, polyvinyl chloride (PVC), and a thermoplastic elastomer (TPE).

The present invention is characterized in adopting the concept of Lego to enable the user to change the shapes and sizes of the massage members freely and acquire diversified massage functions to meet the sports requirements for different exercise intensities.

### BRIEF DESCRIPTION OF THE DRAWINGS

FIG. 1A is a perspective exploded view schematically showing an assembling type sports instrument according to a first embodiment of the present invention;

FIG. 1B is a locally enlarged view of FIG. 1A;

FIG. 1C is a sectional view taken along Line 1C-1C in FIG. 1A;

FIG. 2A is a perspective exploded view schematically showing an assembling type sports instrument according to a second embodiment of the present invention;

FIG. 2B is a sectional view taken along Line 2B-2B in FIG. 2A;

FIG. 2C is a sectional view taken along Line 2C-2C in FIG. 2A;

FIG. 3 is a perspective exploded view schematically showing an assembling type sports instrument according to a third embodiment of the present invention;

FIG. 4 is an assembly drawing schematically showing an assembling type sports instrument according to a fourth embodiment of the present invention;

FIG. 5A is a perspective exploded view schematically showing the assembling type sports instrument according to the fourth embodiment of the present invention;

FIG. 5B is a sectional view taken along Line 5B-5B in FIG. 5A; and

FIG. 6 is a perspective exploded view schematically showing an assembling type sports instrument according to a fifth embodiment of the present invention.

### DETAILED DESCRIPTION OF THE PREFERRED EMBODIMENTS

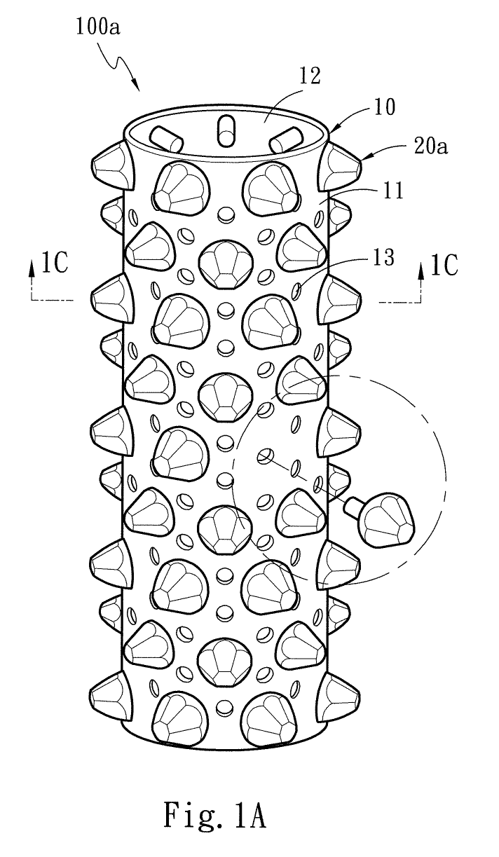

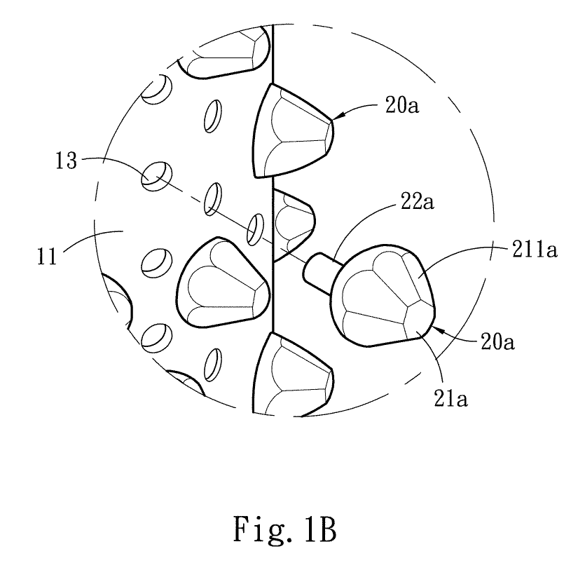

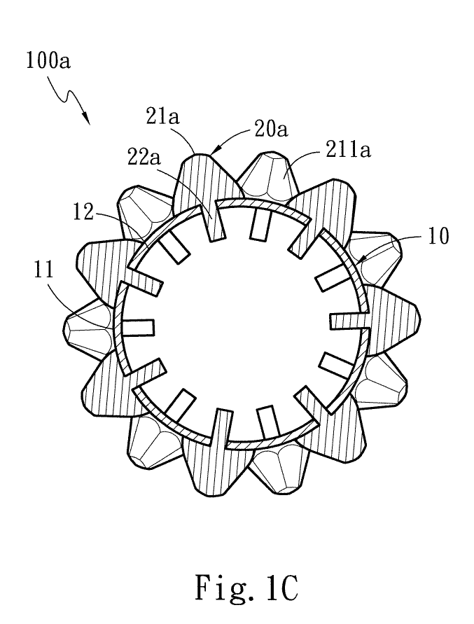

Refer to FIG. 1A for a first embodiment of the present invention. In the first embodiment, the present invention proposes an assembling type sports instrument 100a assisting the user in sport and providing a massage effect. The assembling type sports instrument 100a comprises a hollow column 10 in form of a cylinder and a plurality of assembly parts 20a. The hollow column 10 is made of a durable and wear-resistant material, such as acrylonitrile-butadiene-styrene (ABS) copolymer, polycarbonate (PC), polyethylene (PE), polyvinyl chloride (PVC), or a thermoplastic elastomer (TPE). The assembly parts 20a must be made of an elastic and flexible material, such as polycarbonate (PC), polyethylene (PE), ethylene-vinyl acetate (EVA) copolymer, natural rubber, artificial rubber, polyvinyl chloride (PVC), or a thermoplastic elastomer (TPE), whereby the soft tissue of the user's body can be stretched and massaged while the user rolls the sports instrument of the present invention on his body. However, the abovementioned materials are only used to exemplify but not to limit the materials used by the present invention.

Refer to FIG. 1B and FIG. 1C also. The hollow column 10 includes an outer surface 11 on the outer circumference thereof, an inner surface 12 on the inner circumference thereof, and a plurality of column through-holes 13 each penetrating the outer surface 11 and the inner surface 12. Each assembly part 20a includes a massage member 21a and a connection member 22a connected with the massage member 21a. Each massage member 21a comprises a construction 211a at the end far away from the connection member 22a.

Each connection member 22a can be detachably connected with one of the column through-holes 13. While one assembly part 20a is connected with the column through-hole 13, the construction 211a thereof protrudes from the outer surface 11. In the first embodiment, the construction 211a is in form of a pyramid. The user may install the assembly parts 20a in different positions of the hollow column 10 to form different combinations and achieve different massage effects according to different requirements. In addition to the pyramid shown in FIG. 1A, FIG. 1B and FIG. 1C, the construction 211a may also be in form of a trapezoid, a sphere, a hemisphere, or a tooth in another embodiment of the present invention. The user may store several types of assembly parts 20a whose massage members 21a respectively comprise different constructions 211a so that he can change the constructions 211a to satisfy his requirement.

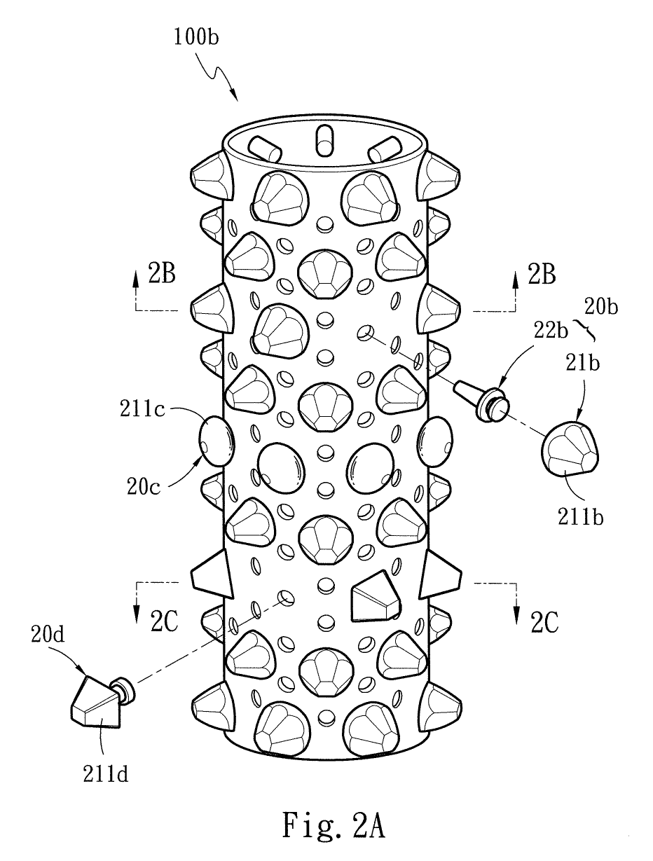

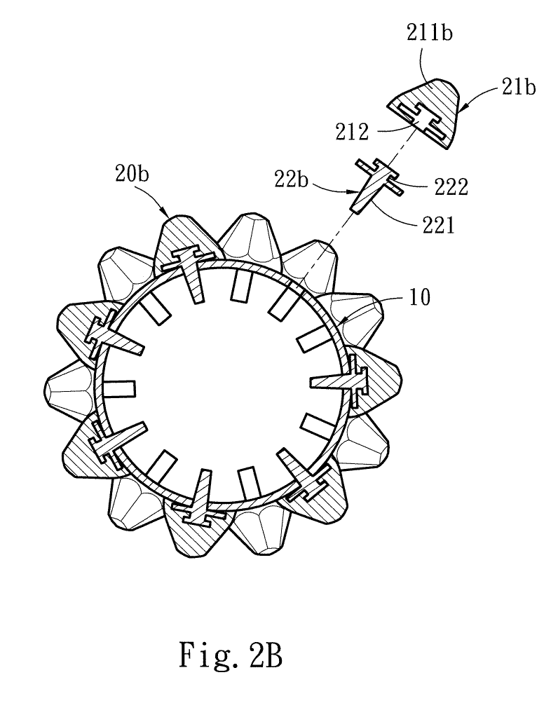

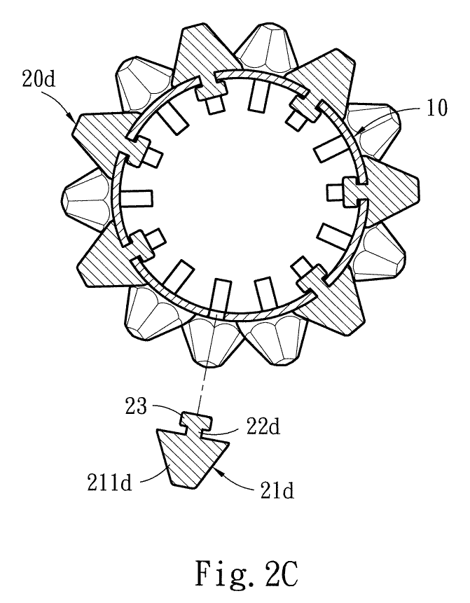

Refer to FIG. 2A and FIG. 2B for a second embodiment of the present invention. In the second embodiment, a portion of the construction 211b of the assembly parts 20b of the assembling type sports instrument 100b are in form of a pyramid; a portion of the construction 211c of the assembly parts 20c are in form of a sphere; a portion of the construction 211d of the assembly parts 20d are in form of a trapezoid. The massage member 21b of the assembly part 20b with a pyramid-shape construction 211b comprises a press-fit socket 212 at the end far away from the construction 211b. Each connection member 22b comprises a connection rod 221, which is to be inserted into the column through-hole 13; and a first press-fit plate 222, which is to be detachably connected with the press-fit socket 212. The connection rod 221 and the column through-hole 13 respectively have tapered shapes corresponding to each other so as to form a secure compressive connection therebetween. However, the present invention does not particularly limit the connection way of the connection member 22b and the column through-hole 13. In one embodiment, the connection of the connection member 22b and the column through-hole 13 is in a screw-threaded hole method. In one embodiment, the contact surfaces of the connection member 22b and the column through-hole 13 are roughened to implement a friction connection.

Refer to FIG. 2A and FIG. 2C where the assembly parts 20d having trapezoid constructions 211d are shown. The connection member 22d of the assembly part 20d comprises a flexible second press-fit plate 23 disposed at one end far away from the massage member 21d and having a diameter greater than that of the column through-hole 13. While the connection member 22 is connected with the column through-hole 13, the second press-fit plate 23 presses against the inner surface 12. In other words, the second press-fit plate 23 is deformed, inserted into the column through-hole 13, restored to the original shape, and then pressed against the inner surface 12. Thus is achieved a secure connection. While the sports instrument of the present invention is rolled in usage, shear stress would be generated in the assembly part 20d. In such a case, the inner surface 12 has a greater resistant force to the second press-fit plate 23 and thus can prevent the assembly part 20d from separating from the hollow column 10. Therefore, the assembly parts 20d are more suitable for the users of higher exercise intensity.

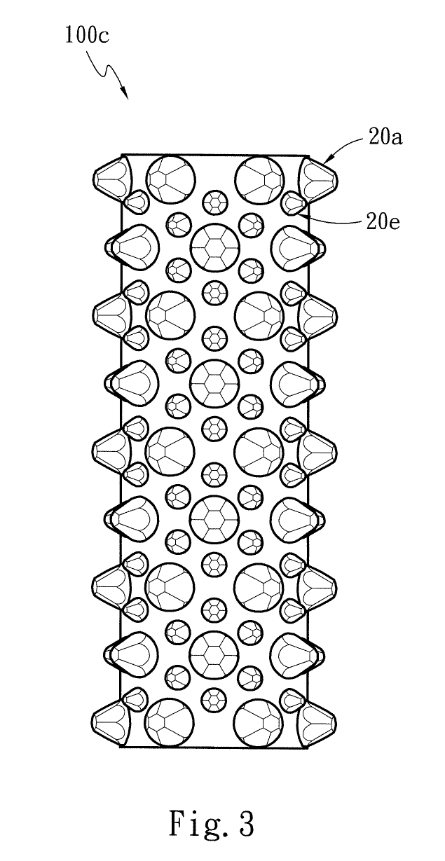

Refer to FIG. 3 for a third embodiment of the present invention. In the third embodiment, the size of a portion of assembly parts 20a is greater than the size of another portion of assembly parts 20e. The user may select the sizes of the assembly parts to meet his requirement.

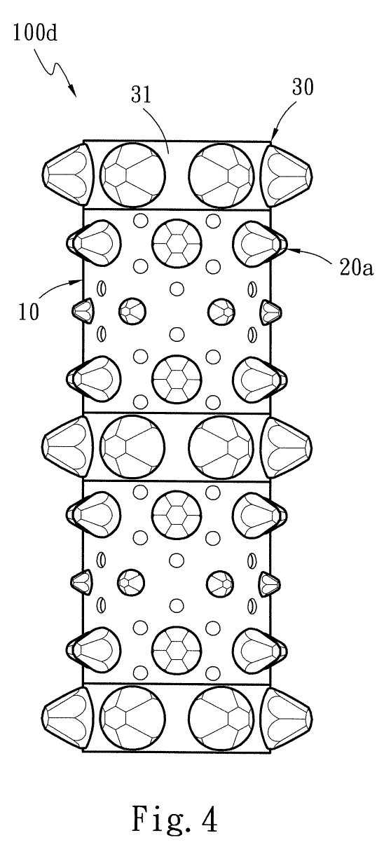

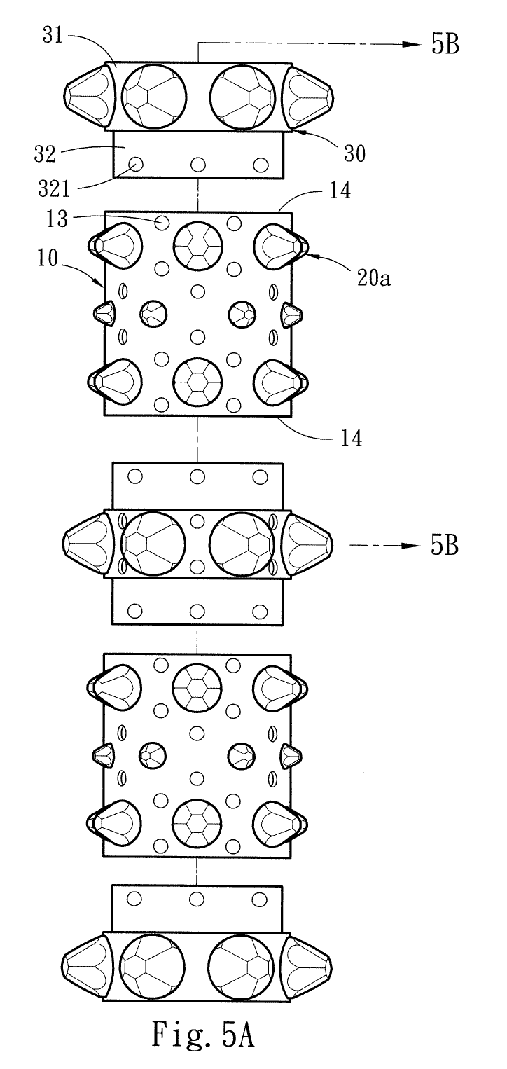

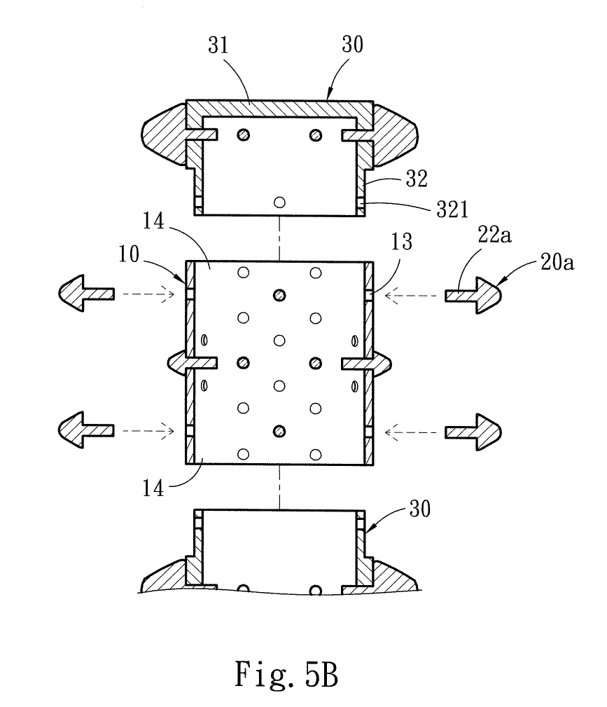

Refer to FIG. 4, FIG. 5A and FIG. 5B for a fourth embodiment of the present invention. In the fourth embodiment, the hollow column 10 of the assembling type sports instrument 100d comprises two open ends 14 respectively at two sides in the axial direction. The assembling type sports instrument 100d further comprises two cap members 30 detachably connected with the open ends 14. The cap member 30 includes a cap body 31 disposed opposite the open end 14, a cap wall 32 extended from the cap body 31 and detachably connected with the open end 14, and a plurality of wall through-holes 321 formed corresponding to the column through-holes 13. In the fourth embodiment, the connection members 22a of the assembly parts 20a are inserted through the wall through-holes 321 and the column through-holes 13 to join the cap member 30 and the hollow column 10 together. In one embodiment, the cap body 31 comprises two ends, which can be respectively connected with two hollow columns 10, whereby the user can expand the length of the cylinder of the assembling type sports instrument 100a.

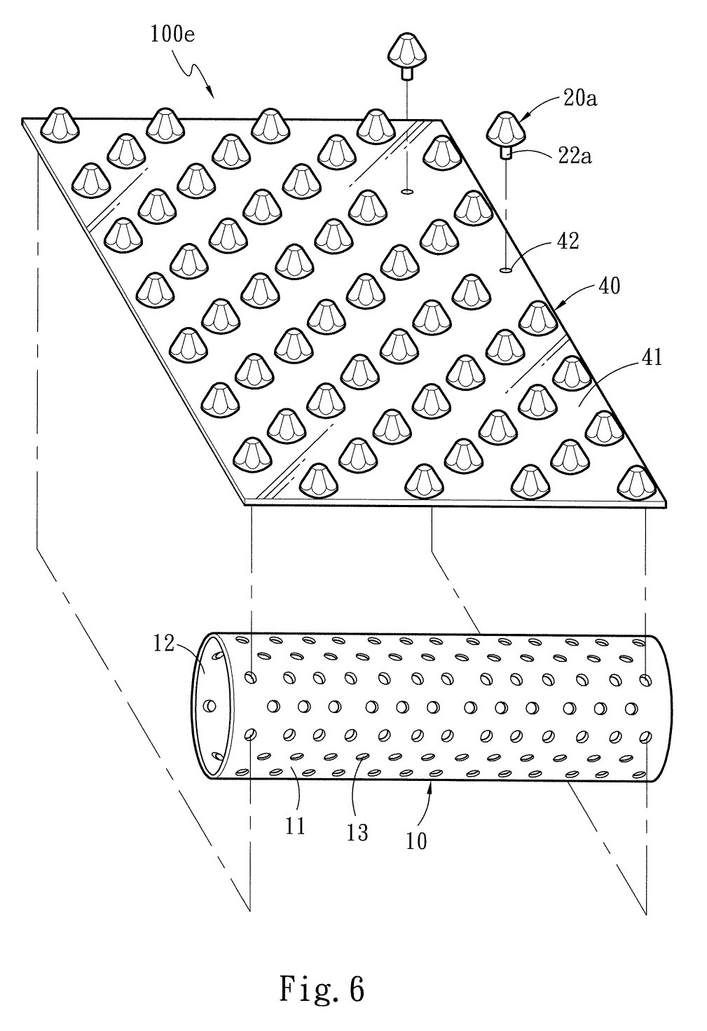

Refer to FIG. 6 for a fifth embodiment of the present invention. In order to convenience the user in assembling the assembly parts 20a to the hollow column 10, the assembling type sports instrument 100e of the present invention further comprises a joint assembly part 40. The joint assembly part 40 includes a joint assembly layer 41 corresponding to the outer surface 11 and a plurality of assembly layer through-holes 42 formed on the joint assembly layer 41 and respectively corresponding to the column through-holes 13. In one embodiment, the joint assembly layer 41 is a flexible plastic pad. The connection member 22a of the assembly part 20a is inserted through the assembly layer through-hole 42 and the column through-hole 13. The user can dispose the assembly parts 20a on the joint assembly layer 41 beforehand and then combine the joint assembly layer 41 with the outer surface 11 of the hollow column 10. Therefore, this embodiment can convenience the assembly operation of the user.

What is claimed is:

1. An assembling type sports instrument comprising
a hollow column including an outer surface on an outer circumference thereof, an inner surface on an inner circumference thereof, and a plurality of column through-holes each penetrating the outer surface and the inner surface; and
a plurality of assembly parts each including a massage member and a connection member connected with the massage member, wherein each massage member comprises a construction at an end thereof, which is far away from the connection member, and wherein each connection member can be detachably connected with one of the column through-holes, and wherein while each assembly part is connected with the column through-hole, the construction thereof protrudes from the outer surface.

2. The assembling type sports instrument according to claim 1, wherein each massage member comprises a press-fit socket at one end thereof, which is far away from the construction, and wherein each connection member comprises a connection rod, which is to be inserted into the column through-hole; and a first press-fit plate, which is to be detachably connected with the press-fit socket.

3. The assembling type sports instrument according to claim 2, wherein the connection rod and the column through-hole respectively have tapered shapes corresponding to each other.

4. The assembling type sports instrument according to claim 1, wherein the hollow column comprises two open ends respectively at two sides in the axial direction, and wherein the assembling type sports instrument further comprises two cap members detachably connected with the open ends.

5. The assembling type sports instrument according to claim 4, wherein the cap member includes a cap body disposed opposite the open end, a cap wall extended from the cap body and detachably connected with the open end, and a plurality of wall through-holes formed corresponding to the column through-holes.

6. The assembling type sports instrument according to claim 1, wherein each connection member comprises a flexible second press-fit plate disposed at one end thereof, which is far away from the massage member, and wherein the second press-fit plate comprises a diameter greater than that of the column through-hole, and wherein while each connection member is connected with the column through-hole, the second press-fit plate presses against the inner surface.

7. The assembling type sports instrument according to claim 1 further comprising a joint assembly part, wherein the joint assembly part includes a joint assembly layer corresponding to the outer surface and a plurality of assembly layer through-holes formed on the joint assembly layer and respectively corresponding to the column through-holes.

8. The assembling type sports instrument according to claim 1, wherein the construction is in form of a pyramid, a trapezoid, a sphere, a hemisphere, or a tooth.

9. The assembling type sports instrument according to claim 1, wherein the hollow column is made of a material selected from the group consisting of acrylonitrile-butadiene-styrene (ABS) copolymer, polycarbonate (PC), polyethylene (PE), polyvinyl chloride (PVC), and a thermoplastic elastomer (TPE).

10. The assembling type sports instrument according to claim 1, wherein the assembly parts are made of a material selected from the group consisting of polycarbonate (PC), polyethylene (PE), ethylene-vinyl acetate (EVA) copolymer, natural rubber, artificial rubber, polyvinyl chloride (PVC), and a thermoplastic elastomer (TPE).
